(19) United States
(12) Patent Application Publication
(10) Pub. No.: US 2008/0193340 A1
(43) Pub. Date: Aug. 14, 2008

(54) Fluidized bed sparger

(76) Inventors: Raymond A. Cocco, Elmhurst, IL (US); Ping Cai, Hurricane, WV (US); Eric B. Foger, Lake Jackson, TX (US); Steve A. Smith, Baton Rouge, LA (US); Philip P. Listak, Lake Jackson, TX (US)

Correspondence Address: The Dow Chemical Company, Intellectual Property Section, P.O. Box 1967, Midland, MI, 48641-1967, US

(21) Appl. No.: 11/704,846

(22) Filed: Feb. 9, 2007

(51) Int. Cl. B01J 19/00

(52) U.S. Cl. 422/143

(57) ABSTRACT

This invention relates to a sparger for injecting a gas-containing feed into a fluidized-bed, wherein the diffuser pipe is angled at least about 12.5° from vertical for gas velocities exiting the diffusers pipe at v less than 45.7 m/sec, and at least about 12.5° exp [0.00131 v] from vertical for gas velocities exiting the diffuser pipe at v equal to or greater than 45.7 m/sec.

### FIELD OF THE INVENTION

This invention relates to the field of fluidized-bed reactors or processors, and in particular, apparatus and methods for delivery of feed fluid to the same.

### BACKGROUND OF THE INVENTION

Fluidized-bed reactors typically are vertical cylindrical vessels equipped with at least one fluid distributor which delivers the process feed or fluidizing fluid (e.g., gas) to the desired locations in the bed, optional internal coils for heat removal or addition, and optional external or internal cyclones to minimize catalyst carryover. Some reactors also have expanded sections in the top to achieve reduced gas velocities for the purpose of minimizing particle carry-over and/or to prohibit undesired dilute-phase reactions. Particulate solid material (e.g., catalyst particles) is fluidized by the fluid from the distributor, and the intimate contact between the fluid and particles assures a good heat/mass transfer between the gas phase and solid phase, resulting in a uniform temperature within the fluidized bed reactor. Reaction heat can be removed or added by the immersed coils, water jacket, fluidizing fluid itself, or by some other heat-transfer medium.

In gas-solid fluidized beds, the distributor is commonly referred as a “gas distributor,” although certain quantities of liquid (e.g., condensates) can also be fed together with the gas through the distributor (as shown in U.S. Pat. No. 4,588,790). Usually, gas distributors in fluidized-bed reactors are intended to introduce the gas into the bed uniformly across the entire cross-sectional area of the reactor, so as to establish a stable fluidization, or to deliver certain feed into certain locations in the bed, such as those side-feeders or non-primary distributors. Preferably, the gas distributors can be operated for long periods of time (e.g., years) without plugging, breaking or other types of mechanical failure, can minimize sifting or backflow of solid particles to upstream of the distributor, can minimize attrition of the bed material, and (for certain types of distributors) can mechanically support the weight of the bed material during the operation.

There are many types of distributors which may be used in fluidized bed reactors. Common distributors include distributor plates/grids which also support the weight of the fluidized bed material, and spargers (also known as multiple-pipe distributors) which do not mechanically support the weight of the fluidized bed material (Kunii and Levenspiel, Fluidization Engineering, 2nd Edition Buttworth-Heineman, 1991). Among the plates/grids, there are perforated plates, porous plates (such as sintered-metal plates), plates with bubble caps, conical grids, and others.

Kunii and Levenspiel describe on page 100 and show in FIG. 7(b), gas coming out of the downward nozzles (diffuser pipes) enters the bed in the form of down-flow jets (also called initial jets). The jets penetrate into the particle bed for a certain distance downstream of the nozzles, then deform and change to relatively small bubbles (called “initial bubbles”). Initial bubbles and all the other bubbles always move upward. On the way up, initial bubbles can absorb gas from the surroundings and/or reduce the pressure to become larger.

Controlled or minimized growth of the bubbles is desirable. Because relatively large bubbles have more gas inside them, the gas has fewer opportunities to be in contact with surrounding particles (e.g., catalyst particles). Relatively large bubbles also move up faster than smaller bubbles, which results in a shorter gas residence time in the bed, and in turn lessen contact between the gas phase and solid phase. Sometimes, bubbles may be broken intentionally (e.g., by baffles) to make them smaller.

U.S. Pat. No. 4,198,210 describes a gasifier with lined discharge nozzles for gas distribution of high temperature gases to a fluidized bed such as beds of coal particles in a coal gasification process. The nozzles have orifice holes that have uniform diameters for a predetermined length, which then extend to the connected nozzle pipes with divergent inner diameters all the way to the ends of those nozzle pipes. The nozzles are aligned axially and are disposed radially at an angle (e.g. 15-45°) relative to the vertical plane passing through the distributor main axis. The nozzles are staggered on opposed sides along the underside portion of the gas inlet pipe. According to this patent, the “nozzles are angularly disposed downwardly away from the fluid be relative to the horizontal plane in order to achieve good gas distribution and also to reduce the possibility of any solids flowing back onto the gas distributor pipes when the fluidizing gas flow ceases or is shut off”. A suitable length for the divergent nozzle pipe is 4 to 8 times the nozzle outlet end diameter which may be in the range of from about ½ to about 2 inches. Suitable gas velocities leaving the nozzle are not described, nor is the relationship between the gas velocity and the angle of nozzles.

U.S. Pat. No. 5,391,356 is directed to a flow distributor in a fluidized bed reactor that comprises a plurality of spaced apart discharge conduits from a plurality of spaced apart locations. Vertical flow diffusers are located in the conduits upstream of the exit openings, but no angled diffuser is mentioned. Those flow diffusers are located in the conduits upstream of the exit openings for flow distribution, instead of connecting to the manifold arm, although equations are provided for calculating the length of and distance between those diffuser pipes.

U.S. Pat. No. 3,298,793 discloses a catalytic reactor having a bottom plate for supporting catalyst and a horizontal manifold sparger mounted on the plate for the gas distribution. Several devices intended to reduce the gas velocity exiting the orifice are described. The sparger has a number of orifices disposed in an even distribution pattern. A diffuser tube with a diameter larger than the orifice directs gas at the bottom plate to fluidize the solids. Alternatively, the diffuser tube is attached to the bottom plate, which is a grid plate with holes. The diffuser tubes have a larger diameter than the holes in grid plate. The diffuser tubes extend initially upward from the grid plate, and then are bent over to direct the gas vertically downward at the grid plate. In an alternative design, the diffuser plates extend upwardly from the grid plate, and have a perforated cap which directs the gas laterally at the surface of the grid plate. In this configuration, a coarse material (a filter bed) is packed around the diffuser plates and caps to prevent fine solids from entering the plenum below the grid plate. However, stand-alone spargers not mounted on a plate are not mentioned by this patent.

U.S. Pat. No. 4,223,843 is an air distributor apparatus for a fluidized catalyst cracking (“FCC”) fluidized-bed regenerator, wherein nozzles are mounted to a header ring on a cylindrical housing that is connected to high pressure air. Each nozzle has a diverging, or flared, bore with a half-angle of less than 7 degrees. The only type of sparger described by this patent is a sparger supported by a head ring.

U.S. Pat. No. 4,443,551 describes an apparatus and method of delivering air specifically to a spent catalyst bed in an FCC fluidized-bed regenerator, with decreased interior erosion in the nozzles by reducing particle “draw up” into the nozzle, and with reduced power consumption. The method includes feeding the high velocity gas through an air ring and deflecting the gas downward via a nozzle that is attached to the air ring at an angle of 30-75 degrees to the flow of air in the air ring.

### SUMMARY OF THE INVENTION

There is a need in the art for an improved apparatus for distributing a gas-containing feed in a fluidized-bed reactor or other fluidized-bed equipment. Preferably, use of the improved apparatus will result in more uniform feed of the gas-containing feed in the reactor, lower catalyst attrition, less coalescence of initial bubbles and less erosion of the immersed reactor interiors such as the external surfaces of sparger manifold arms and diffuser pipes.

The present invention comprises a sparger for injecting a gas-containing feed into a fluidized-bed. The sparger includes a main pipe which is connected to a source of the gas-containing feed, and at least one manifold arm connected to the main pipe for conducting the gas-containing feed. The manifold arm has at least one nozzle connected to it for conducting the gas-containing feed from the manifold arm to a fluidized-bed located outside the sparger. The nozzle includes an orifice and a diffuser pipe. The gas-containing feed passes through the nozzle at a flow rate and the gas-containing feed exits the diffuser pipe at a gas-containing feed velocity, v. For gas-containing feed velocities exiting the diffuser pipes at v less than 45.7 m/sec, the diffuser pipe is angled at least about 12.5° from vertical. For gas-containing feed velocities exiting the diffuser pipes at v equal to or greater than 45.7 m/sec, the diffuser pipe is angled at least about 12.5° exp [0.00131 v] from vertical.

In one embodiment of the invention, the sparger has at least two diffuser pipes and each diffuser pipe has a tip. The minimum horizontal distance between the tips of any two diffuser pipes is equal or larger than

$${k}_{1} \frac{{( {u}_{o} - {u}_{mf} )}^{{k}_{2}}}{π} ,$$

where uₒ=Superficial Gas Velocity in the bottom of the Bed, u_{mf}=Minimum Fluidization Velocity, the value of k₁ is from about 0.5 to about 2.5, and the value of k₂ is from about 1 to about 2.25. In another embodiment, the value of k₁ is from about 0.55 to about 1.1 and the value of k₂ is from about 1 to about 1.25 for gas-containing feed flow rates passing through the nozzle at equal or greater than 0.0003 m³/sec per nozzle; and the value of k₁ is from about 2.4 to about 5.1 and the value of k₂ is from about 2 to about 2.25 for gas-containing feed flow rates passing the nozzle at less than 0.0003 m³/sec per nozzle. The orifice has a size between about 1 and about 30 mm. In another aspect of the invention, the velocity of the gas-containing feed leaving the tip of the diffuser pipe is less than or equal to about 75 m/sec, preferably less than or equal to about 47.5 m/sec, and even more preferably less than or equal to about 21.3 m/sec.

In another embodiment of the present invention, at least one diffuser pipe is angled at least about 18.5° from vertical for gas-containing feed velocities, v, exiting the diffuser pipe, at less than 45.7 m/sec, and at least about 18.5° exp [0.00131 v] from vertical for gas-containing feed velocities exiting the diffuser pipe, v, at equal to or greater than 45.7 m/sec.

In one embodiment, one or more diffuser pipes have been treated by a surface-hardening process. In another embodiment, the length of at least one diffuser pipe is at least about 1 to about 2 times the impingement length of a diverging gas flow, starting at the center point of the orifice, at a 22° cone angle. In one embodiment, the pressure drop across the sparger is at least about 10% to about 100% of the pressure drop across the fluidized bed.

In one aspect, the sparger is used in a fluidized bed which is operated under a bubbling fluidization regime or turbulent fluidization regime.

### BRIEF DESCRIPTION OF THE DRAWINGS

The drawings diagrammatically illustrate by way of example, not by way of limitation, one form of the invention wherein like reference numerals designate corresponding parts in the several views in which:

FIG. 1 is a schematic cross-sectional depiction of a fluidized-bed reactor containing an embodiment of the sparger of the present invention;

FIG. 2(a) is a schematic cross-sectional view of the sparger as viewed from the plane A-A of FIG. 1;

FIG. 2(b) is a side view of a manifold arm and nozzles shown along plane A-A of FIG. 1;

FIG. 3 is a schematic cross-sectional depiction of one embodiment of the nozzle of the present invention; and

FIG. 4 is a schematic depiction of the impingement length of a diverging gas flow, started at the center point of the orifice, at a 22° cone angle.

### DETAILED DESCRIPTION OF THE INVENTION

Many types of spargers can benefit from the present invention, particularly those used in fluidized beds operated with different particle properties such as particle size, particle size distribution, density, and sphericity. The spargers of the present invention which are used in gas-solid fluidized-bed reactors can be operated under different flow regimes such as homogeneous fluidization, bubbling fluidization, turbulent fluidization, slugging, and fast fluidization (see Kunii and Levenspiel, 1991). The sparger of the present invention is particularly relevant for use in the bubbling and turbulent fluidization regimes, commonly used in commercial dense-phase fluidized-bed reactors.

Examples of the reactions which can use the sparger of the present invention are chemical catalytic reactions (e.g., oxidation of chlorinated hydrocarbons, catalytic oxychlorination, catalytic ammoxidation of propylene to produce acrylonitrile), fluidized catalyst cracking (FCC) of petroleum, coal combustion and gasification, and polymerization.

The sparger of the present invention includes at least one main pipe (also known as a “main manifold”) connected to source of a gas-containing feed, with at least one, and usually a number of, branching manifolds (also known as “manifold arms”) connected to the main pipe, to divide the gas-containing feed into many streams. Nozzles are present along the branching manifolds to deliver the gas-containing feed into the bed. As a part of the nozzle, a relatively small piece of pipe known as a diffuser pipe or shroud pipe is located downstream of the hole (or “orifice”) on the wall of the manifold. The diffuser pipe stabilizes the flow of the gas-containing feed out of the orifice and prevents particles being drawn into the manifold pipe.

The gas-containing feed from the tip of each diffuser pipe enters the bed in the form of gas jets or bubbles, with a velocity substantially higher than the gas-containing feed velocity in the fluidized bed. The jets and bubbles entering the bed can apply a strong “sand blasting” or erosion effect on the surfaces they contact. Therefore, the angle of injection of the gas-containing feed, which is controlled by the angle of the diffuser pipe, determines the extent of erosion of the diffuser pipe (especially external surfaces), other parts of the sparger, and even the reactor wall.

In a fluidized bed with sparger-type gas distributor, the horizontal distance between neighboring nozzles or their diffuser pipes is important in determining the bubble size. If two diffuser pipes are very close, the initial bubbles from them can coalesce soon after their formation, and then the bubbles would be larger than those without the coalescence of the initial bubbles. Larger bubbles move up faster than small bubbles. Therefore, the relatively large momentum of the large bubbles in turn increases the severity of erosion to the sparger (external surface) and nearby immersed surfaces. If the distance between the neighboring diffuser pipes is too large, the uniformity of distribution of the gas-containing feed (in cross-sectional area) decreases. Relatively large bubbles resulting from excessive bubble coalescence also negatively impact the chemical reaction in the reactor, because the gas-to-solid mass transfer is reduced by the relatively large volume of “un-touched” gas inside the bubble, and more gas can “by-pass” the bed as big bubbles without sufficiently contacting the solid phase.

The diameter of each of the orifices and diffuser pipes are also important. The proper orifice diameter mainly determines the overall pressure drop across the sparger, while the diffuser pipe diameter impacts the jet velocity entering the bed. If the diffuser pipe diameter is too small, the exiting gas-containing feed stream has a very high initial velocity which can cause particle attrition. On the other hand, if both the orifice diameter and diffuser pipe diameters are too large, thereby generating a small pressure drop across the sparger, the sparger can become unstable and the distribution of the gas-containing feed may not be uniform across the cross-sectional area of the reactor. In addition, if the diffuser pipe diameter is too large, the sparger may not provide sufficient momentum of gas injection into the bed, which has a negative impact on the desired intimate contact between gas phase and solid phase. In this case, heat and mass transfer in the bed are reduced.

The length of the diffuser pipe also affects sparger performance. A very short diffuser pipe does not stabilize the jet of gas-containing feed. Particles can enter the diffuser pipe and approach the orifice, which increases particle attrition. If the diffuser pipe is too long, there is no further stabilization of the jet of gas-containing feed, and bubbles contacting the manifold arm may have sizes larger than desired. The particles may also be carried back into the diffuser pipe by a vortex. An ideal diffuser pipe length is long enough to stabilize the jet of gas-containing feed (i.e., reaching the fully developed turbulent flow at the exit of the diffuser pipe).

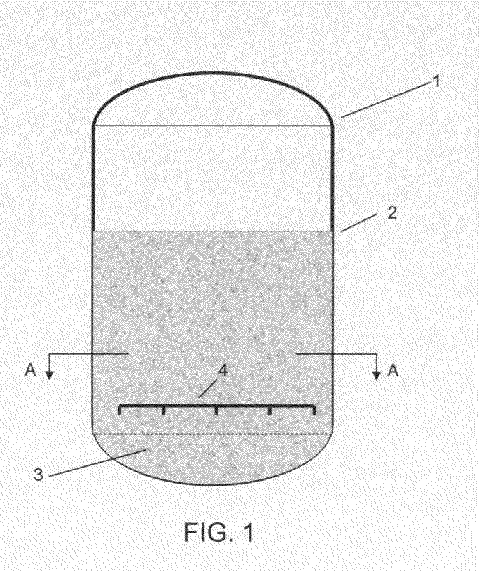

Referring now in detail to the drawings and initially to FIG. 1, a fluidized-bed reactor is designated generally by reference number 1. The fluidized-bed reactor 1 includes a reactor vessel 2 in which a gas-solid, liquid-solid or gas-liquid-solid contacting process occurs. In the reactor, a bed of finely divided solid particles (e.g., a fluidized-bed catalyst) 3 is lifted and suspended (“fluidized”) by the process fluid (gas, or liquid, or gas-liquid mixture) entering through a sparger 4.

The process feed of the present invention is a gas-containing feed, which is a feed which comprises at least about 51% by weight of the feed in the gaseous state.

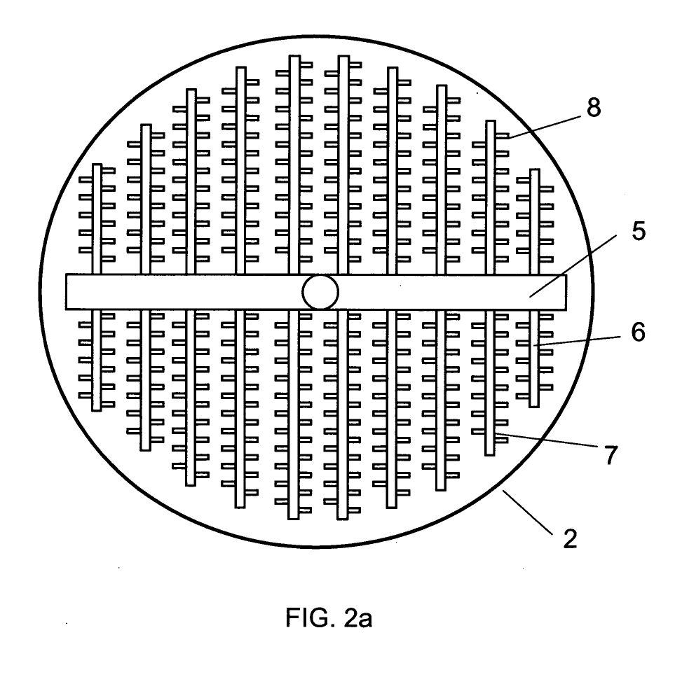

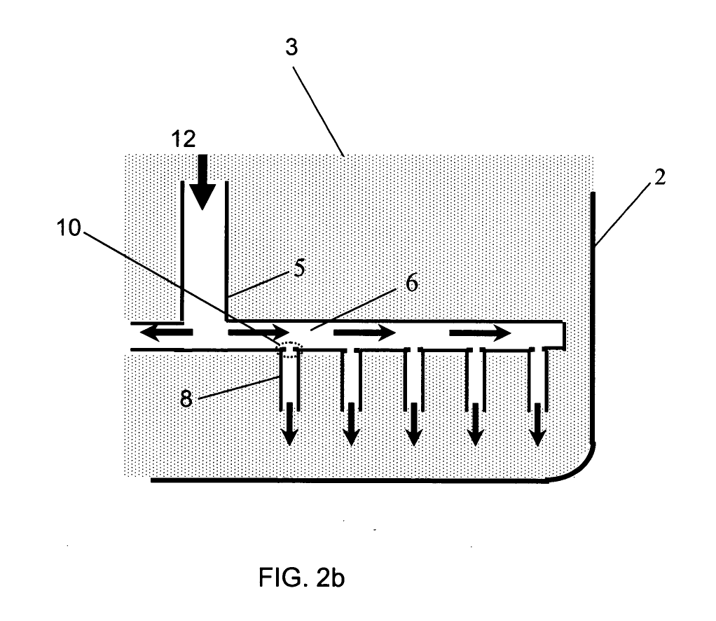

With reference to FIG. 2a, reactor vessel 2 has disposed therein, for delivery of a gas-containing feed, an exemplary sparger 4 constructed in accordance with the present invention. The sparger 4 includes a main manifold 5, one or more manifold arms 6 with walls 7 and one or more nozzles 8 on the manifold arms.

Referring to FIG. 2b, the gas-containing feed (12) is fed through the main manifold 5 into the manifold arms 6 for dispersion through an orifice 10 exiting into the diffuser pipe 8 into a fluidized catalyst bed 3 contained in the reactor vessel 2. Preferably, the velocity of the gas-containing feed in any part of the main manifold or manifold arms does not exceed 24 m/sec; velocities in excess of 24 m/sec may result in excessive pressure drop across the manifold arm, increased catalyst attrition, and erosion of the sparger.

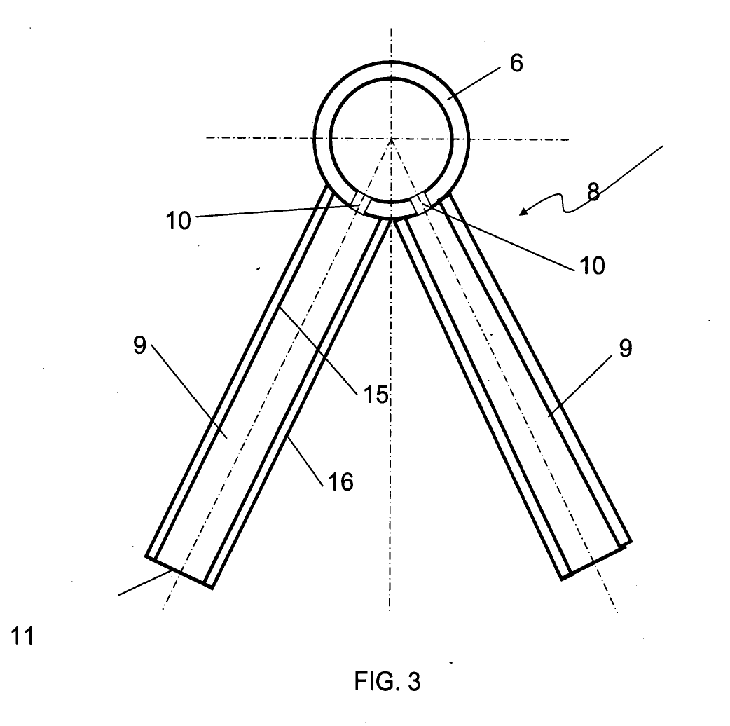

As depicted in FIG. 2a, the manifold arm 6 in turn contains multiple nozzles 8. As shown in FIG. 3, each nozzle has a diffuser pipe 9 downstream of orifice 10. The diffuser pipe of the nozzle is affixed to (such as by welding) the manifold arm to guide the gas-containing feed stream out of the orifice 10 to provide for distribution of the gas-containing feed transversely across the fluidized-bed reactor 2. Each of the diffuser pipes ends in a tip 11. Each diffuser pipe has inner and outer walls, 15 and 16. The orifice is typically a small round hole, either straight or flared, with a diameter in the range of about 1 to about 30 mm. The diffuser pipes are preferably made of metals that have high resistance to corrosion and erosion, such as those which have been treated by a surface hardening process. As shown in FIG. 2b, the manifold arms 6 extend transversely outwardly from the main manifold 5. That is, the manifold arms 6 extend in a perpendicular, or T-shaped or “fish-bone” shaped, relative to the main manifold 5. In one embodiment (not depicted), a manifold arm has at least one second-level or multiple-level manifold arm(s) connected to it. The manifold arms may be the same or different sizes. In one embodiment, the sparger includes a main manifold, several manifold arms, and several nozzles on each manifold arm.

For fluidized beds two or more feet in height, the sparger pressure drop preferably is at least about 10% to 50% of the bed pressure drop. For fluidized beds less than two feet in height, the preferred sparger pressure drop is at least about 30% to 100% of the bed pressure drop. Sufficient pressure drop across the sparger plays an increased role in those embodiments where one or more injectors and/or or one or more additional spargers are located above the first sparger. In such embodiments, an insufficient first sparger pressure drop is more likely to result in gas bypassing, undesired excessive bubble coalescence, channeling, higher catalyst attrition and/or higher erosion rates.

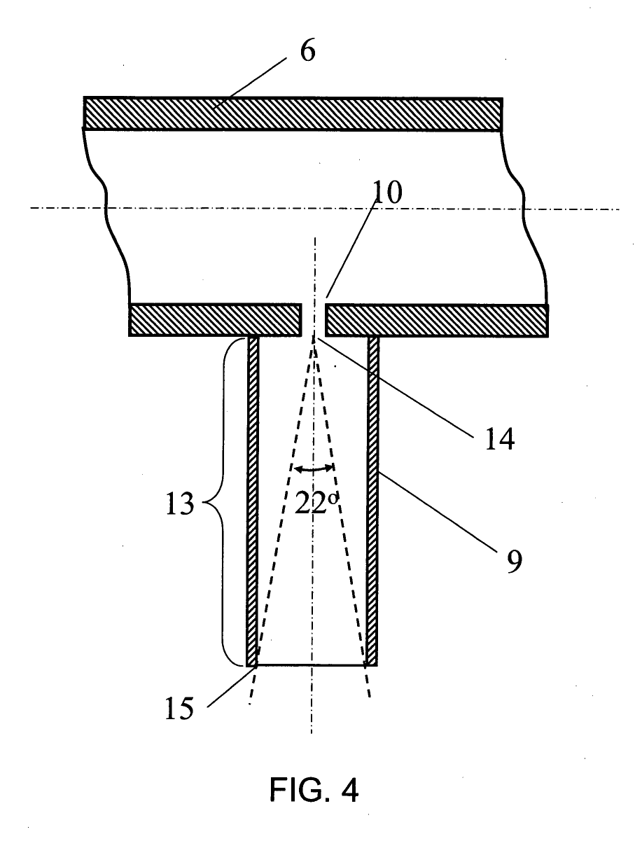

FIG. 4 depicts the impingement length of a diverging gas flow. This length 13 is the straight distance along the diffuser pipe from the orifice to a point that is defined by a line which proceeds from the center of the orifice 14 at a 22° cone angle and intersects the inner wall 15 of the diffuser pipe 9. The preferred diffuser pipe length is at least about 1 to 2 times the impingement length. The minimum diffuser pipe length is any length longer than the impingement length of a diverging gas flow at a 22° cone angle, and, preferably, at least two times this length. The diffuser pipe diameter preferably corresponds to the desired jet velocity at the tip of the diffuser pipe.

In order to prevent or reduce sparger erosion caused by bubbles which move upward with relatively high velocity and carry particles with them, the diffuser pipes are angled at least about 12.5°, and preferably at least about 18.5° from vertical for velocities of gas-containing feed, v, exiting the diffuser pipe at less than 45.7 m/sec. In those embodiments where the velocities of the gas-containing feed exiting the diffuser pipe is equal to or greater than 45.7 m/sec, the diffuser pipes preferably are angled at least about 12.5° exp [0.00131 v] from vertical, and more preferably at least about 18.5° exp [0.00131 v] from vertical. In addition, the exit of the diffuser pipe is preferably a sufficient distance from that of the neighboring diffuser pipe, to prevent unnecessary bubble coalescence and to reduce erosion.

Diffuser pipes are horizontally spaced sufficiently apart from each other to prevent jet impingement and thus reduce catalyst attrition. The correlation for the minimum horizontal distance between the tips of any two diffuser pipes (i.e., minimum “staggered spacing”) can be expressed by the formula

$$l \geq {k}_{1} \frac{{( {u}_{o} - {u}_{mf} )}^{{k}_{2}}}{π}$$

where uₒ=Superficial Gas Velocity in the bottom of the Bed, u_{mf}=Minimum Fluidization Velocity (a function of particle properties), k₁ is from about 0.5 to about 2.5 and k₂ is from about 1 to about 2.25. Preferably, k₁ is from about 0.55 to about 1.1 and k₂ is from about 1 to about 1.25 for gas flow rates passing the nozzles at equal or greater than 0.0003 m³/sec per nozzle, and k, is from about 2.4 to about 5.1 and k₂ is from about 2 to about 2.25 for gas flow rates passing the nozzles at less than 0.0003 m³/sec per nozzle.

The preferred jet velocity (i.e., the velocity of the gas-containing feed leaving the tip of the diffuser pipe) will differ depending upon the type of catalyst (e.g. attrition-resistant catalyst vs. attrition-prone catalyst). Severe attrition can result in significant loss of bed material even when a particle collection device (such as an internal or external cyclone to return most of particles entrained from the dense bed, and/or an expanded section in the upper part of the reactor with larger diameter to further reduce the gas velocity) is used. In general, the jet velocities do not exceed 75 m/sec, preferably do not exceed 47.5 m/sec, and most preferably do not exceed 30.5 m/sec for attrition-resistant catalysts. For attrition-prone catalysts, the jet velocities generally do not exceed 21.3 m/sec and preferably do not exceed 15 m/sec. The diameter of the diffuser pipe can be changed to achieve the desired jet velocity.

The following examples are provided to illustrate the invention, but are not intended to limit the scope thereof.

### EXAMPLES

### Example 1

### A Comparative Example, not Part of the Invention

The catalytic oxidation of chlorinated hydrocarbons occurred in a commercial-scale fluidized-bed reactor where the particles in the fluidized bed were attrition-prone catalyst particles belonging to Group A of Geldart Particle Classification (Geldart, 1972), and gaseous oxidants were fed into the bed via a sparger comprising a manifold pipe with multiple manifold arms. The reactor was operated under the bubbling fluidization regime, with a superficial gas velocity of about 0.2 m/sec. The manifold arms were equipped with multiple vertically downward diffuser pipes having a wall thickness of about 6.35 mm. The length of the diffuser pipe is about 5.9 times of the impingement length of a diverging gas flow, started at the center point of the orifice, at a 22° cone angle. The center-to-center distance between two neighboring diffusion pipes is about 2.1 times of the minimum horizontal distance between any two diffuser pipes. The gas-containing feed through the sparger was controlled to properly fluidize the bed. The gas-containing feed velocity at the tips of the diffuser pipe tips exceeded about 24 m/sec. At an open-reactor inspection after 6 months of operation, many diffuser pipes were found to have suffered erosion damage in the nature of holes through the diffuser pipe wall. Replacement diffuser pipes were required. Catalyst loss was measured. Despite the use of a 2-stage cyclone system, the catalyst-loss rate during the operation was about 1.84 kg per hour, per square meter of bed cross-sectional area, mainly caused by particle attrition.

### Example 2

### One Embodiment of the Sparger Apparatus of the Present Invention

The catalytic oxidation of chlorinated hydrocarbons was conducted using the same reactor and operating conditions as in Example 1, except that one embodiment of the sparger of the present invention was substituted for the sparger of Example 1. The diffuser pipes of the sparger measured 20 degrees from the vertical, and the gas-containing feed velocity at the tip of the diffuser pipes was about 9 m/sec. The length of the diffuser pipe was about 3.4 times of the impingement length of a diverging gas flow, started at the center point of the orifice, at a 22° cone angle. The center-to-center distance between two neighboring diffusion pipes was about 2.3 times of the minimum horizontal distance between any two diffuser pipes. After 6 months of operation, an open-reactor inspection found that the most severe wall-thickness reduction of diffuser pipes due to erosion was no more than 0.8 mm. Catalyst loss was also measured. During the operation, the catalyst loss was about 0.74 kg per hour, per square meter of bed cross-sectional area, because of reduced particle attrition.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon the foregoing description. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A sparger for injecting a gas-containing feed into a fluidized-bed, comprising:
a main pipe connected to a source of the gas-containing feed,
at least one manifold arm connected to the main pipe for conducting the gas-containing feed;
at least one nozzle connected to the manifold arm for conducting the gas-containing feed from the manifold arm to a fluidized-bed located outside the sparger;
wherein the at least one nozzle includes an orifice and a diffuser pipe;
wherein the gas-containing feed passes through the nozzle at a flow rate;
wherein the gas-containing feed exits the diffuser pipe at a gas velocity, v; and
wherein the diffuser pipe is angled at least about 12.5° from vertical for gas velocities exiting the diffusers pipe at v less than 45.7 m/sec, and at least about 12.5° exp [0.00131 v] from vertical for gas velocities exiting the diffuser pipe at v equal to or greater than 45.7 m/sec.

2. The sparger of claim 1, wherein there are at least two diffuser pipes, wherein each diffuser pipe has a tip, and wherein the minimum horizontal distance between the tips of any two diffuser pipes is equal or larger than
$${k}_{1} \frac{{( {u}_{o} - {u}_{mf} )}^{{k}_{2}}}{π} ,$$
where uₒ=Superficial Gas Velocity in the bottom of the Bed, u_{mf}=Minimum Fluidization Velocity, the value of k₁ is from about 0.5 to about 2.5, and the value of k₂ is from about 1 to about 2.25.

3. The sparger of claim 2, wherein the value of k₁ is from 0.55 to 1.1 and the value of k₂ is from about 1 to about 1.25 for gas flow rates passing through the nozzle at equal or greater than 0.0003 m³/sec per nozzle; and the value of k₁ is from about 2.4 to about 5.1 and the value of k₂ is from about 2 to about 2.25 for gas flow rates passing the nozzle at less than 0.0003 m³/sec per nozzle.

4. The sparger of claim 3 wherein the fluidized bed is operated under a bubbling fluidization regime or turbulent fluidization regime.

5. The sparger of claim 1 wherein the orifice has a size between about 1 and about 30 mm.

6. The sparger of claim 1 wherein the diffusers have been treated by a surface-hardening process.

7. The sparger of claim 1 wherein the pressure drop across the sparger is at least about 10% to about 100% of the pressure drop across the fluidized bed.

8. The sparger of claim 1 wherein the gas velocity leaving the tip of the diffuser pipe is less than or equal to about 75 m/sec.

9. The sparger of claim 8 wherein the gas velocity leaving the tip of the diffuser pipe is less than or equal to about 47.5 m/sec.

10. The sparger of claim 9 wherein the gas velocity leaving the tip of the diffuser pipe is less than or equal to about 21.3 m/sec.

11. The sparger of claim 1 wherein the length of at least one diffuser pipe is at least about 1 to 2 times of the impingement length of a diverging gas flow, started at the center point of the orifice, at a 22° cone angle.

12. The sparger of claim 1 wherein the at least one diffuser pipe is angled at least about 18.5° from vertical when v is less than 45.7 m/sec, and at least about 18.5° exp [0.00131 v] from vertical when v is equal to or greater than 45.7 m/sec.
